(19) United States
(12) Patent Application Publication
(10) Pub. No.: US 2025/0142392 A1
(43) Pub. Date: May 1, 2025

(54) COHERENT WIRELESS COMMUNICATION METHOD BASED ON TERMINAL FEEDBACK, AND APPARATUS FOR THE SAME

(71) Applicant: ELECTRONICS AND TELECOMMUNICATIONS RESEARCH INSTITUTE, Daejeon (KR)

(72) Inventors: Cheulsoon KIM, Daejeon (KR); Sung-Hyun MOON, Daejeon (KR); Junghoon LEE, Daejeon (KR)

(21) Appl. No.: 18/927,771

(22) Filed: Oct. 25, 2024

(30) Foreign Application Priority Data
Oct. 25, 2023 (KR) 10-2023-0143720
Dec. 5, 2023 (KR) 10-2023-0174913
Mar. 21, 2024 (KR) 10-2024-0039290
Oct. 11, 2024 (KR) 10-2024-0138978

(51) Int. Cl. H04W 24/10; H04B 7/06; H04L 27/26

(52) U.S. Cl. CPC H04W 24/10; H04B 7/0626; H04L 27/265

(57) ABSTRACT

A method of a terminal may comprise: receiving a first downlink (DL)-reference signal (RS) and a second DL-RS from a first transmission and reception point (TRP) and a second TRP among two or more TRPs; reporting a measurement report based on the first DL-RS and the second DL-RS to one TRP among the first TRP and the second TRP; and receiving data through joint transmission performed by the first TRP and the second TRP based on the measurement report.

### CROSS-REFERENCE TO RELATED APPLICATIONS

This application claims priority to Korean Patent Applications No. 10-2023-0143720, filed on Oct. 25, 2023, No. 10-2023-0174913, filed on Dec. 5, 2023, No. 10-2024-0039290, filed on Mar. 21, 2024, and No. 10-2024-0138978, filed on Oct. 11, 2024, with the Korean Intellectual Property Office (KIPO), the entire contents of which are hereby incorporated by reference.

### BACKGROUND

### 1. Technical Field

The present disclosure relates to a wireless communication method, and more particularly, to a coherent wireless communication method based on a terminal's feedback in a mobile communication system, and an apparatus for the same.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

The 5G communication system (e.g. communication system supporting the NR) using a higher frequency band (e.g. frequency band of 6 GHz or above) than a frequency band (e.g. frequency band of 6 GHz or below) of the 4G communication system is being considered for processing of wireless data soaring after commercialization of the 4G communication system (e.g. communication system supporting the LTE). The 5G communication system can support enhanced mobile broadband (eMBB), ultra-reliable low-latency communication (URLLC), massive machine type communication (mMTC), and the like. Discussion on a sixth generation (6G) communication system after the 5G communication system is in progress.

Meanwhile, in the 5G and 6G communication systems, communication using multiple transmission and reception points (TRPs) can be utilized. In particular, in multi-TRP communication, methods and procedures for acquiring synchronization between TRPs are necessary for joint transmission and reception between the TRPs.

### SUMMARY

The present disclosure for achieving the above-described objective is directed to providing a method of a terminal for synchronization acquisition between TRPs in multi-TRP communication.

The present disclosure for achieving the above-described objective is directed to providing a method of a TRP for synchronization acquisition between TRPs in multi-TRP communication.

The present disclosure for achieving the above-described objective is directed to providing a terminal apparatus for synchronization acquisition between TRPs in multi-TRP communication.

According to a first exemplary embodiment of the present disclosure, a method of a terminal may comprise: receiving a first downlink (DL)-reference signal (RS) and a second DL-RS from a first transmission and reception point (TRP) and a second TRP among two or more TRPs; reporting a measurement report based on the first DL-RS and the second DL-RS to one TRP among the first TRP and the second TRP; and receiving data through joint transmission performed by the first TRP and the second TRP based on the measurement report.

Each of the first DL-RS and the second DL-RS may be at least one of a synchronization signal block (SSB), a channel state information (CSI)-RS, or a tracking reference signal (TRS).

The one TRP may be the first TRP, which is a serving TRP for the terminal, and the measurement report or information derived from the measurement report may be transmitted from the first TRP to the second TRP via backhaul or Xn interface.

The measurement report may include at least one of a time offset measured between the first DL-RS and the second DL-RS, a frequency offset measured between the first DL-RS and the second DL-RS, or a joint offset of the time offset and the frequency offset, and may follow a CSI report configuration.

The time offset, the frequency offset, or the joint offset may be included in the measurement report as an absolute value or a relative value.

The first DL-RS and the second DL-RS may be received with a common discrete Fourier transform (DFT) window applied, or may be received with different DFT windows applied.

When different DFT windows are applied to the first DL-RS and the second DL-RS, the measurement report may include an indicator indicating that different DFT windows are applied to the first DL-RS and the second DL-RS.

The measurement report may include at least one of an autocorrelation measured for each of the first DL-RS and the second DL-RS or a cross-correlation measured for the first DL-RS and the second DL-RS.

When the first DL-RS and the second DL-RS are TRSs, the first DL-RS and the second DL-RS may be received and measured in different slots, and downlink reception coherence of the terminal may be assumed to be maintained in the different slots.

A periodic or semi-persistent reporting according to a CSI report framework may be configured for one DL-RS among the first DL-RS and the second DL-RS, and an aperiodic reporting according to the CSI report framework may be configured for another DL-RS among the first DL-RS and the second DL-RS.

According to a second exemplary embodiment of the present disclosure, a method of a first transmission and reception point (TRP) may comprise: transmitting a first downlink (DL)-reference signal (RS) to a terminal; receiving, from the terminal, a measurement report based on the first DL-RS and a second DL-RS transmitted by a second TRP to the terminal; and transmitting data to the terminal by performing joint transmission together with the second TRP based on the measurement report.

The first DL-RS may be at least one of a synchronization signal block (SSB), a channel state information (CSI)-RS, or a tracking reference signal (TRS).

The first TRP may be a serving TRP for the terminal, and the measurement report or information derived from the measurement report may be transmitted from the first TRP to the second TRP via backhaul or Xn interface.

The measurement report may include at least one of a time offset measured between the first DL-RS and the second DL-RS, a frequency offset measured between the first DL-RS and the second DL-RS, or a joint offset of the time offset and the frequency offset, and may follow a CSI report configuration.

When the terminal applies different DFT windows to the first DL-RS and the second DL-RS, the measurement report may include an indicator indicating that different DFT windows are applied to the first DL-RS and the second DL-RS.

The measurement report may include at least one of an autocorrelation measured for each of the first DL-RS and the second DL-RS or a cross-correlation measured for the first DL-RS and the second DL-RS.

According to a third exemplary embodiment of the present disclosure, a terminal may comprise: at least one processor and a transceiver, and the at least one processor may be configured to perform: receiving, through the transceiver, a first downlink (DL)-reference signal (RS) and a second DL-RS from a first transmission and reception point (TRP) and a second TRP among two or more TRPs; reporting, through the transceiver, a measurement report based on the first DL-RS and the second DL-RS to one TRP among the first TRP and the second TRP; and receiving, through the transceiver, data through joint transmission performed by the first TRP and the second TRP based on the measurement report.

Each of the first DL-RS and the second DL-RS may be at least one of a synchronization signal block (SSB), a channel state information (CSI)-RS, or a tracking reference signal (TRS).

The one TRP may be the first TRP, which is a serving TRP for the terminal, and the measurement report or information derived from the measurement report may be transmitted from the first TRP to the second TRP via backhaul or Xn interface.

The measurement report may include at least one of a time offset measured between the first DL-RS and the second DL-RS, a frequency offset measured between the first DL-RS and the second DL-RS, a joint offset of the time offset and the frequency offset, an autocorrelation measured for each of the first DL-RS and the second DL-RS, or a cross-correlation measured for the first DL-RS and the second DL-RS.

According to exemplary embodiments of the present disclosure, when communication using multiple TRPs is utilized in the 5G and 6G communication systems, synchronization between TRPs can be acquired based on a terminal's measurement on DL-RSs transmitted by the TRPs and a result feedback of the measurement. Through this, joint transmission, reception, and joint scheduling between the TRPs can be efficiently performed.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram describing a configuration example of a CSI report config.

FIG. 4 is a conceptual diagram describing a relationship between TRS resource sets, slots, and TRS symbols.

FIG. 5 is a conceptual diagram describing a delay for reporting a correlation of TRS.

FIG. 6 is a conceptual diagram describing a time/frequency synchronization method between TRPs based on a report of a terminal according to an exemplary embodiment of the present disclosure.

FIG. 7 is a conceptual diagram describing a method for determining a time offset between TRPs according to an exemplary embodiment of the present disclosure.

FIG. 8 is a conceptual diagram describing DFT windows applied to TRPs according to an exemplary embodiment of the present disclosure.

FIG. 9 is a conceptual diagram describing a method for determining a frequency offset between TRPs according to an exemplary embodiment of the present disclosure.

FIG. 10 is a conceptual diagram describing configuration of TRS resource sets according to an exemplary embodiment of the present disclosure.

FIG. 11 and FIG. 12 are conceptual diagrams describing configuration of TRS resource sets according to an exemplary embodiment of the present disclosure.

FIG. 13 is a conceptual diagram illustrating the TRP resource sets illustrated in FIGS. 11 and 12 in one drawing.

FIG. 14 is a conceptual diagram describing a method of transmitting beam quality-related measurement information in preconfigured time resources according to an exemplary embodiment of the present disclosure.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may be used in the same sense as a communication network.

In exemplary embodiments, ‘configuration of an operation (e.g. transmission operation)’ may mean ‘signaling of configuration information (e.g. information element(s), parameter(s)) for the operation’ and/or ‘signaling of information indicating performing of the operation’. ‘Configuration of information element(s) (e.g. parameter(s))’ may mean that the corresponding information element(s) are signaled. The signaling may be at least one of system information (SI) signaling (e.g. transmission of system information block (SIB) and/or master information block (MIB)), RRC signaling (e.g. transmission of RRC message(s), RRC parameter(s) and/or higher layer parameter(s)), MAC control element (CE) signaling (e.g. transmission of a MAC message and/or MAC CE), PHY signaling (e.g. transmission of downlink control information (DCI), uplink control information (UCI), and/or sidelink control information (SCI)), or a combination thereof.

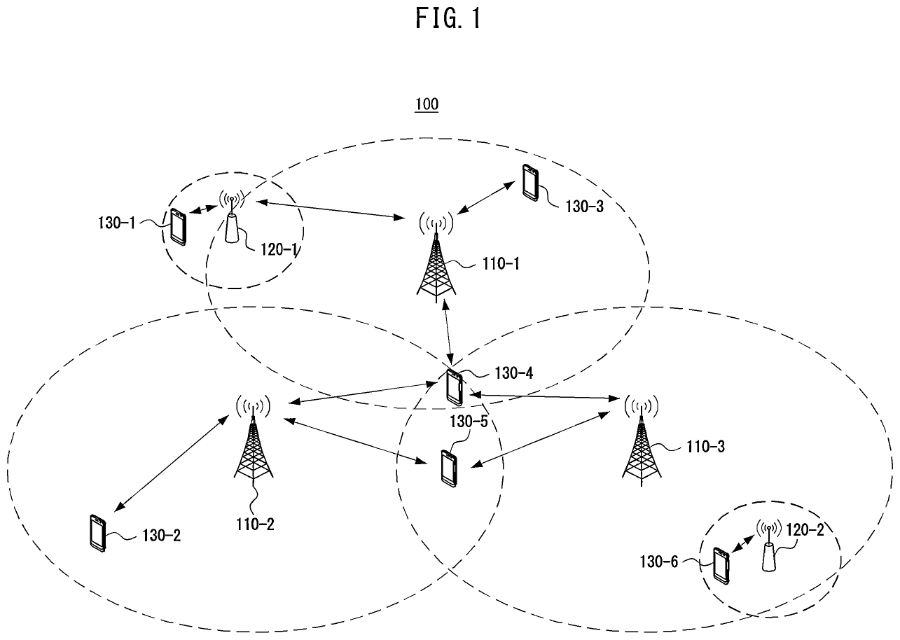

FIG. 1 is a conceptual diagram illustrating a first exemplary embodiment of a communication system.

Referring to FIG. 1, a communication system 100 may include a plurality of communication nodes 110-1, 110-2, 110-3, 120-1, 120-2, 130-1, 130-2, 130-3, 130-4, 130-5, and 130-6. In addition, the communication system 100 may further include a core network (e.g. serving-gateway (S-GW), packet data network (PDN)-gateway (P-GW), and mobility management entity (MME)). When the communication system 100 is the 5G communication system (e.g. NR system), the core network may include an access and mobility management function (AMF), a user plane function (UPF), a session management function (SMF), and the like.

The plurality of communication nodes 110 to 130 may support the communication protocols (e.g. LTE communication protocol, LTE-A communication protocol, NR communication protocol, etc.) defined by technical specifications of 3rd generation partnership project (3GPP). The plurality of communication nodes 110 to 130 may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like. Each of the plurality of communication nodes may have the following structure.

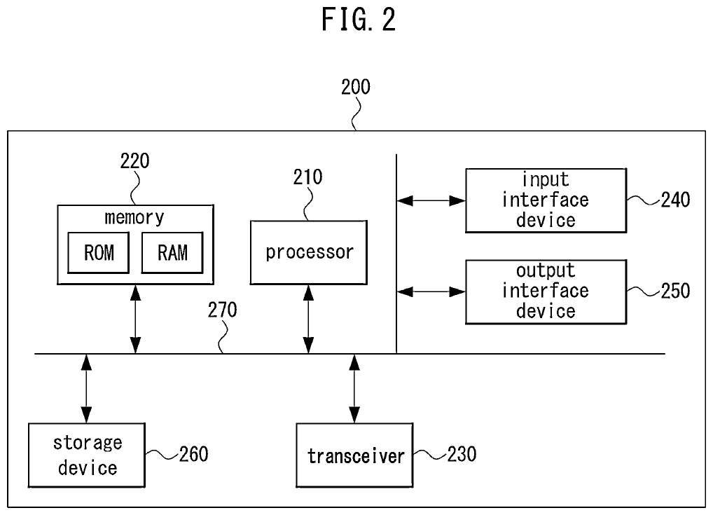

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, an evolved Node-B (eNB), an advanced base station (BTS), a high reliability-base station (HR-BS), a base transceiver station (BTS), a radio base station, a radio transceiver, an access point, an access node, a radio access station (RAS), a mobile multi-hop relay base station (MMR-BS), a relay station (RS), an advanced relay station (ARS), a high reliability-relay station (HR-RS), a home NodeB (HNB), a home eNodeB (HeNB), a roadside unit (RSU), a radio remote head (RRH), a transmission point (TP), a transmission and reception point (TRP), or the like.

Each of the plurality of terminals 130-1, 130-2, 130-3, 130-4, 130-5, and 130-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g. a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, device-to-device (D2D) communication (or, proximity services (ProSe)), Internet of Things (IoT) communications, dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e. the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, operation methods of a communication node in a communication system will be described. Even when a method (e.g. transmission or reception of a data packet) performed at a first communication node among communication nodes is described, the corresponding second communication node may perform a method (e.g. reception or transmission of the data packet) corresponding to the method performed at the first communication node. That is, when an operation of the terminal is described, the corresponding base station may perform an operation corresponding to the operation of the terminal. Conversely, when an operation of the base station is described, the corresponding terminal may perform an operation corresponding to the operation of the base station.

In order to reduce an error rate of data, a low modulation and coding scheme (MCS) level (or, low MCS index) may be applied. In order not to increase a size of a field indicated by downlink control information (DCI), frequently used MCS(s) may be selected. In order to apply a lower MCS, a repeated transmission operation may be supported. In case of applying a quadrature phase shift keying (QPSK) which is the lowest modulation rate, an effect of further reducing the code rate may occur. In particular, since a transmit power is limited in uplink (UL) transmission, the repeated transmission operation may be performed in the time domain rather than in the frequency domain.

In the case of eMBB traffic and URLLC traffic, a lower MCS may be used for different purposes, respectively. For example, for eMBB traffic, a lower MCS may be required to extend a coverage. On the other hand, for URLLC traffic, a lower MCS may be required to reduce a latency and achieve a lower error rate. Since the requirements are different, the eMBB traffic may be repeatedly transmitted even when a relatively large latency occurs. The URLLC traffic may be transmitted using new MCSs (e.g. low MCS) rather than the repeated transmission. The new MCS may be configured by an RRC message and/or a DCI.

In order to support repeated transmissions for the eMBB traffic in the time domain, a physical uplink shared channel (PUSCH) repetition (e.g. PUSCH repetition type A) may be introduced. In this case, a PUSCH allocated on a slot basis may be repeatedly transmitted. To extend a coverage, a time resource may be allocated over a plurality of slots. When the PUSCH repetition type A is used, the time resource may be configured by an RRC message and/or a DCI. The number of repetitions of the PUSCH may be indicated by the RRC message, and a time resource for transmitting the PUSCH in the first slot may be indicated by the DCI (e.g. in case of type 2 configured grant (CG) or dynamic grant) or the RRC message (e.g. in case of type 1 CG).

Since a latency occurs when the URLLC traffic is repeatedly transmitted, it may not be appropriate to repeatedly transmit the URLLC traffic. However, when a sufficiently low MCS is used, a latency for decoding the URLLC traffic may be reduced. That is, when a sufficiently low MCS is used, the number of resource elements (REs) to which the URLLC traffic is mapped may increase, and the base station (e.g. a decoder of the base station) should wait until all the REs are received. In this case, the latency for decoding the URLLC traffic may be reduced.

However, when a PUSCH to which a rather high MCS is applied is repeatedly transmitted, the base station may perform the decoding only with some REs. Therefore, a timing at which decoding is successful in the repeated PUSCH transmission (e.g. repeated transmission of the PUSCH to which a somewhat high MCS is applied) may be earlier than a timing at which decoding is successful in the non-repeated PUSCH transmission (e.g. transmission of the PUSCH to which a low MCS is applied). When the PUSCH repetition type A is used, an unnecessary latency may occur, and a PUSCH repetition type B may be introduced to reduce the latency due to the repeated transmission. When the PUSCH repetition type B is used, a PUSCH allocated on a mini-slot basis may be repeatedly transmitted. When the PUSCH repetition type B is used, a time resource may be configured by an RRC message and/or DCI. A combination of a reference time resource of a PUSCH instance and the number of repeated transmissions may be indicated by the DCI (e.g. in case of Type 2 CG and/or dynamic grant) or the RRC message (e.g. in case of Type 1 CG).

In order to control a transmission power of a sounding reference signal (SRS) resource indicated by an SRS resource indicator (SRI), the base station may estimate a path loss for each SRS resource. The base station may control a transmission power of SRS resource(s) by using DCI. The transmission power of the SRS resource(s) may be controlled based on the estimated path loss. The DCI may be scheduling DCI (e.g. DCI format 0_0, DCI format 0_1, DCI format 0_2, DCI format 10, DCI format 11, or DCI format 1_2) or group-common (GC)-DCI (e.g. DCI format 2_2 or DCI format 23). The DCI may include a field indicating a transmit power control (TPC) command, and the TPC command may be used to control a transmission power of the terminal. For example, the transmission power of the terminal may be increased or decreased based on the TPC command included in the DCI. In order to determine a transmission power of a PUSCH, the terminal may consider a value obtained based on a path loss, a value according to the TPC command included in the DCI, and/or a PUSCH bandwidth indicated by the DCI.

The base station may configure two or more sets to the terminal using higher layer signaling. The terminal may receive configuration information of the two or more sets from the base station. Element(s) constituting each of the two or more sets may be transmission power parameter(s), and may be indicated to be suitable for different scenarios (e.g. URLLC scenario, eMBB scenario). The terminal may receive scheduling DCI or activating DCI for allocating a PUSCH resource from the base station, and the scheduling DCI or the activating DCI may indicate a set for interpreting transmission power parameter(s). When a set of transmission power parameter(s) is different, a magnitude of increasing or decreasing the transmission power indicated by the same TPC command may be different.

When Type 1 CG or Type 2 CG is used, a transmission power may be determined based on a DCI format 2_3 for an SRI associated with a PUSCH instance. When Type 2 CG is used, activating DCI may indicate a set of transmission power parameter(s) applied to a PUSCH occasion. The PUSCH occasion may mean a PUSCH instance. The terminal may obtain a TPC command for an SRI by receiving GC-DCI, and may interpret the TPC command to be suitable to the set of transmission power parameter(s) indicated by the base station, and may derive a transmission power to be applied to the PUSCH instance based on a result of the interpretation.

In transmitting a dynamically-scheduled PUSCH, the terminal may derive a transmission power applied to a PUSCH instance based on a combination of GC-DCI and scheduling DCI. By receiving the GC-DCI, the terminal may identify a TPC command of an SRI and store the identified TPC command. In transmitting a dynamically-scheduled PUSCH, a set of transmission power parameter(s) and/or a TPC command applied to a PUSCH occasion may be indicated by scheduling DCI. The terminal may derive a transmission power to be applied to a PUSCH instance based on a transmission power of an SRI associated with the PUSCH instance.

Repeated HARQ-ACK transmission may be indicated (or configured) by higher layer signaling for each physical uplink control channel (PUCCH) format. The number of repeated transmissions for a PUCCH format i may be independently set. i may be 1, 3, or 4. The terminal may repeatedly transmit a PUCCH format through slots. In this case, the PUCCH format may be transmitted using the same time resource in the respective slots.

The type of uplink control information (UCI) may be classified according to a type of information included in the UCI. The UCI may include at least one of a scheduling request (SR), L1-reference signal received power (L1-RSRP), HARQ-ACK, channel state information (CSI), or combinations thereof. In exemplary embodiments, UCI and UCI type may be used with the same meaning. In a repeated transmission operation of UCI, only one UCI type may be transmitted. In order to support this operation, a priority of each UCI type may be defined in the technical specification. One UCI type may be selected, and a PUCCH including the one UCI type may be repeatedly transmitted. In this case, the terminal may assume that no other UCI type is transmitted before the transmission of the corresponding UCI type is completed. In order to support this operation, the base station may instruct the terminal to transmit UCI (e.g. SR or HARQ-ACK) after transmission of the corresponding PUCCH is completed. A waiting time for the UCI transmission may be large, and the waiting time may act as a constraint on scheduling of the base station.

When it is indicated to transmit HARQ-ACKs in the same slot (or the same subslot) or when PUCCH time resources indicated by DCI(s) and/or RRC message(s) for allocating physical downlink shared channel(s) (PDSCH(s)) overlap each other, the terminal may generate a HARQ codebook so as to be transmitted on one PUCCH (e.g. one PUCCH time resource). In the HARQ codebook, HARQ-ACK bits may be arranged according to an order defined in the technical specification. Information bits may be generated by the above-described operation. The terminal may generate coded bits by performing an encoding operation thereon.

In the encoding operation, a Reed-Muller code or a polar code may be used. A code rate applied in the encoding operation may be indicated by higher layer signaling. For example, one value in the PUCCH format may be the code rate and may be indicated to the terminal.

One codeword may be mapped to one PUCCH. In a repeated PUCCH transmission operation, one UCI type may be generated as a codeword. When a PUCCH is transmitted once, information bits of one UCI type or two or more UCI types may be concatenated, and the terminal may generate one codeword by performing the same encoding operation on the information bits. When a Reed-Mûller code or a polar code is used, it may be difficult to implement a soft combining operation. Accordingly, even when the PUCCH is repeatedly transmitted, the same codewords may be transmitted, and the base station may perform a chase combining operation on the same codewords. The coded bit or codeword may mean a bit stream in which a plurality of code blocks are concatenated. A modulation operation may be performed on the codeword, and a result of the modulation operation may be mapped to resource elements (REs).

Meanwhile, the same UCI types may be regarded as different information. The same UCI types considered as different information may be mapped. For example, UCIs may be generated to support traffic having different priorities. A UCI (e.g. SR or HARQ-ACK) supporting eMBB traffic may be regarded as information different from a UCI (e.g. SR or HARQ-ACK) supporting URLLC traffic. In this case, even when the UCI types are the same, they may be distinguished as different information.

The coded UCI may be mapped to a PUCCH. In a PUCCH transmission operation, the same preprocessing scheme (e.g. spatial information, spatial relation) may be maintained. Alternatively, in the PUCCH transmission operation, use of a different preprocessing scheme for each PUCCH may be allowed by RRC signaling of the base station.

In order to support URLLC traffic, it may be preferable for the terminal to perform frequent reception operations in downlink (DL) resources and/or frequent transmission operations in uplink (UL) resources. In a time division duplex (TDD) system, the terminal may operate based on a half-duplex scheme. Accordingly, a time of supporting DL traffic and/or UL traffic may increase according to a slot pattern. On the other hand, in a frequency division duplex (FDD) system, the terminal may utilize DL resources and UL resources at the same time. Accordingly, the above-described problem in the TDD system may not occur in the FDD system. The FDD system may use two or more carriers. When two or more serving cells are configured to the terminal in the TDD system, the terminal may utilize DL resources and UL resources.

In a communication system including at least one carrier to which the FDD is applied (hereinafter, referred to as ‘FDD carrier’), there may be no problem with respect to a latency of the terminal. In a communication system including only carrier(s) to which the TDD is applied (hereinafter, referred to as ‘TDD carrier(s)’), there may be a problem with respect to a latency of the terminal. In order to solve the above problem, slots in the TDD carriers may be configured according to different patterns.

Carrier aggregation (CA) may be configured in the terminal, and a PCell and SCell(s) may be activated. Depending on whether a common search space (CSS) set is included, a cell may be classified into a PCell or an SCell. For example, the PCell may include a CSS set, and the SCell may not include a CSS set. In order to reduce a latency in a communication system supporting URLLC traffic, slots having different patterns may be configured and/or indicated to the terminal.

The eMBB traffic or URLLC traffic may be supported in a licensed band, but may also be supported in an unlicensed band. Carrier(s) belonging to a licensed band or carrier(s) belonging to an unlicensed band may be used alone, but depending on configuration of the base station, all of the carrier(s) belonging to the licensed band and the carrier(s) belonging to the unlicensed band may be utilized through frequency aggregation.

In exemplary embodiments, two or more terminals may receive data from one or more TRPs, and may transmit data to one or more TRPs. It may be assumed that one base station or one server performs a management operation and/or a scheduling operation for one or more TRPs among a plurality of TRPs. The TRPs may be directly connected with each other. Alternatively, the TRPs may be connected through the base station. The above-described connections may be connections according to Xn interfaces or wireless interfaces (e.g. interfaces of the 3GPP NR).

A shadow area may occur between areas supported by the TRPs. Therefore, the TRPs may resolve the shadow area through cooperative transmissions. The cooperative transmissions may be performed for a terminal located between the TRPs. Even when a shadow area does not occur, a quality of radio links may be improved by installing many TRPs (or base stations) to transmit and receive a lot of data.

According to a cooperative transmission and a cooperative reception of the TRPs, a communication scheme may be classified into dynamic point selection (DPS) and joint transmission (JT). For a specific physical resource block (PRB) set, the DPS may be a scheme of receiving data through one TRP, and the JT may be a scheme of receiving data through two or more TRPs. A dynamic point blanking (DPB) scheme may be a type of the JT. When the DPB is used, the terminal may not receive data from some TRPs and may receive data from the remaining TRPs. The JT may be classified into coherent JP and noncoherent JP. Depending on whether a coherent combining operation is performed on signals received from TRPs, the coherent JP or the non-coherent JP may be used.

Depending on a latency and traffic allowance of a backhaul network to which the base stations or TRPs are connected, the TRPs may or may not participate in cooperative transmission and reception in real time. The terminal may support JT through one DCI (i.e. single DCI (sDCI)). Alternatively, the terminal may support JT through multiple DCIs (i.e. multi-DCI (mDCI)).

In case of using sDCI, the terminal may transmit and receive data with TRPs. In case of using sDCI, it may be preferable for TRPs to be able to cooperate through the backhaul network without a latency. In case of using mDCI, the terminal may transmit and receive data with some TRPs. When the terminal transmits and receives data with other TRPs, it is difficult for these TRPs to cooperate in real time through the backhaul network, so it may be preferable to allocate semi-static resources to these TRPs.

In the existing technical specifications, a CORESET pool index has been introduced to identify a TRP. A CORESET pool is a set of CORESETs, and a transmission configuration indication (TCI) state applied to each CORESET may be independently indicated to the terminal through RRC signaling and/or MAC control element (CE) signaling. Therefore, a CORESET pool index may not necessarily correspond to a TRP. More specifically, if a TRP is classified into a transmission point (TxP) and a reception point (RxP), a CORESET pool index may correspond to an RxP. For example, an Rx beam received from a TxP may be derived from a TCI state, and uplink signals/channels scheduled by DCIs detected in CORESETs belonging to a CORESET pool indicated by one CORESET pool index may be interpreted as being received from the same RxP.

In order for a terminal to obtain a gain through coherent combining, there needs to be a certain degree of synchronization between TRPs for the terminal, and CSI reports for the TRPs need also to be shared. In case where these are not possible, it is advantageous in terms of performance to perform noncoherent combining in the terminal.

When a terminal is mounted on a vehicle, restrictions on the size and weight of the terminal may be relaxed. However, in case of a terminal carried by a person, portability of the terminal may be taken into consideration.

Small cells or IAB nodes may be deployed to extent signal's reach. A throughput of a small cell or IAB node may be affected by a quality of a backhaul link, and securing the backhaul network may be expensive. As an alternative to this, a wireless relay device may be deployed to deliver higher quality signals to the terminal. The wireless relay devices may be classified into several types depending on a method of delivering signals. As a wireless relay device supports more functions, it can show performance similar to that of a base station, and as a wireless relay device supports fewer functions, it can be deployed at a lower cost. The wireless relay device considered in the present disclosure may perform a function of forming beams to terminals, but may perform a minimum function of transmitting data. The base station needs to transmit wireless signals to control these wireless relay devices. Appropriate parameters for the wireless relay device may be configured using these wireless signals.

Downlink signals that a terminal can receive from a base station may include a synchronization signal block (SSB), a channel state information (CSI)-reference signal (RS), and the like. An SSB may be a block including a primary synchronization signal (PSS), a secondary synchronization signal (SSS), and a physical broadcast channel (PBCH), and it may be assumed that a PSS, SSS, and PBCH constituting one SSB are transmitted through the same transmission (Tx) beam. When operating multiple Tx beams in a TRP, a Tx beam corresponding to each SSB index may be managed for the terminal by transmitting multiple SSBs.

The CSI-RS may be utilized for various purposes. For example, the CSI-RS may be utilized for a purpose of CSI estimation, a purpose of downlink fine synchronization tracking, a purpose of downlink beam management, and the like. The CSI-RS may be configured (or indicated) in connection with a CSI report configuration (CSI report config).

Considering a CSI report config, for one CSI report quantity, a CSI resource configuration for channel measurement and a CSI resource configuration for interference measurement may be distinguished. Here, the CSI report quantity may include, for example, cri-RI-PMI-CQI, cri-RI-LI-PMI-CQI, cri-RI-il, cri-RI-il-CQI, cri-RI-CQI, cri-RSRP, ssb-index-RSRP, cri-SINR, and ssb-index-SINR. Each CSI report quantity may be reported from the terminal to the TRP (or serving cell, base station) for MIMO operations. If the CSI report quantity is configured to ‘none’ or omitted, CSI may not be reported from the terminal to the TRP.

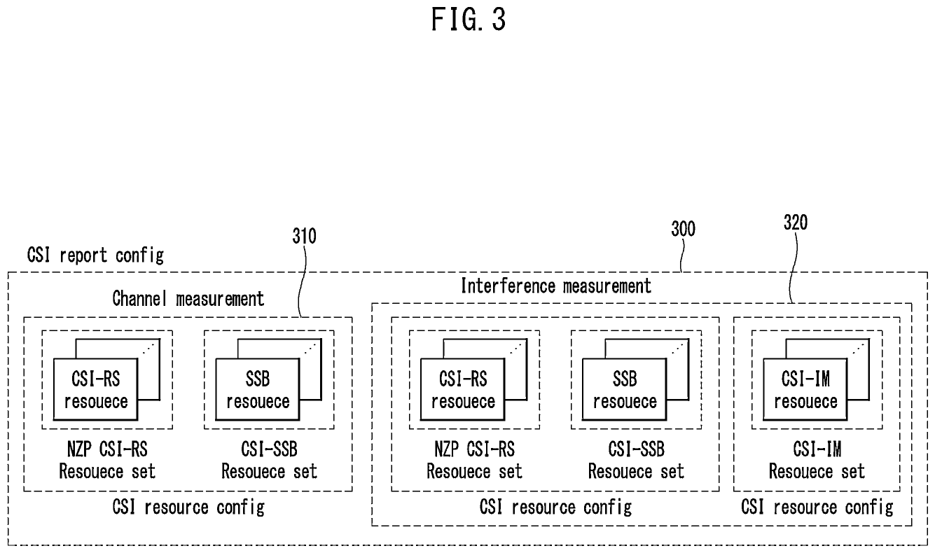

FIG. 3 is a conceptual diagram describing a configuration example of a CSI report config.

Referring to FIG. 3, a CSI resource config 310 for channel measurement, which is associated with a CSI report config 300, may configure (or indicate) non-zero power (NZP) CSI-RS resource set(s) and/or CSI SSB resource set(s). On the other hand, a CSI resource config 320 for interference measurement, which is associated with the CSI report config 300, may configure (or indicate) NZP CSI-RS resource set(s) and/or CSI SSB resource set(s). In addition, the CSI resource config for interference measurement may configure (or indicate) CSI-interference measurement (IM) resource set(s). In order to configure (or indicate) CSI-RS(s) in a NZP CSI-RS resource set, a CSI-RS resource set may be configured (or indicated) and one or more CSI-RS resources may be included in the configured (or indicated) CSI-RS resource set.

A NZP CSI-RS resource set may include one or more NZP CSI-RS resources. A CSI-IM resource set may include one or more zero power (ZP) CSI-RS resources.

CSI reporting schemes may be classified into periodic reporting, semi-persistent reporting, and aperiodic reporting. In the case of periodic/semi-persistent reporting, a time resource (e.g. slot) in which a PUCCH or PUSCH carrying CSI is transmitted may be derived from RRC signaling and/or MAC CE. On the other hand, in the case of aperiodic reporting, a time resource (e.g. slot) in which a PUSCH carrying CSI is transmitted may be derived from UL-DCI. The UL-DCI may dynamically indicate a resource of the PUSCH on which CSI according to aperiodic reporting is transmitted.

Even when CSI reporting is not performed, the CSI-RS may be used to perform downlink maintenance (e.g. fine time synchronization tracking and fine frequency synchronization tracking). For example, a TRS, which is a type of CSI-RS resource, may be configured (or indicated) to the terminal through RRC signaling (e.g. trs-Info), and the terminal may receive the TRS periodically. Alternatively, transmission of a TRS may be triggered dynamically, and the terminal receive the TRP dynamically.

All NZP CSI-RS resources belonging to a NZP CSI-RS resource set may have the same port index(es). Alternatively, all NZP CSI-RS resources belonging to a NZP CSI-RS resource set may have the same number of ports.

In the case of operating in FR1, one or more NZP CSI-RS resource sets may be configured (or indicated) to the terminal. One NZP CSI-RS resource set may include four periodic NZP CSI-RS resources. ANZP CSI-RS may be received in two consecutive slots, and each slot may include two periodic NZP CSI-RS resources.

In the case of operating in FR2, one or more NZP CSI-RS resource sets may be configured (or indicated) to the terminal. One NZP CSI-RS resource set may include two periodic NZP CSI-RS resources in one slot, or may include four periodic NZP CSI-RS resources in two consecutive slots, in which case each slot may include two periodic NZP CSI-RS resources.

A TRS may be received in one slot or two adjacent slots. The TRS may be received in two symbols per slot, and a spacing between the two symbols is fixed to a predetermined number of OFDM symbols (e.g. four OFDM symbols). Since a TRS symbol 1 and a TRS symbol 2 received in the same slot have the same port index, phases of the TRS symbol 1 and TRS symbol 2 are measured differently during a channel estimation process performed by the terminal, and accordingly time synchronization and/or frequency synchronization may be corrected.

DL maintenance may be performed using the TRS, and the TRS may be mainly utilized when the terminal has low mobility. However, the TRS may also be utilized when the terminal has high mobility.

When the terminal and the TRP have mobility, the terminal may receive the TRS from the TRP and measure a difference in phases of the TRS symbols. By considering this phase difference as a result of a Doppler effect, the mobility of the terminal can be offset. To this end, the terminal may receive one or more TRS resources continuously. The terminal may receive the TRS resources, calculate a correlation therefrom, and report a quantized correlation (i.e. time domain correlation profile (TDCP)) to the base station.

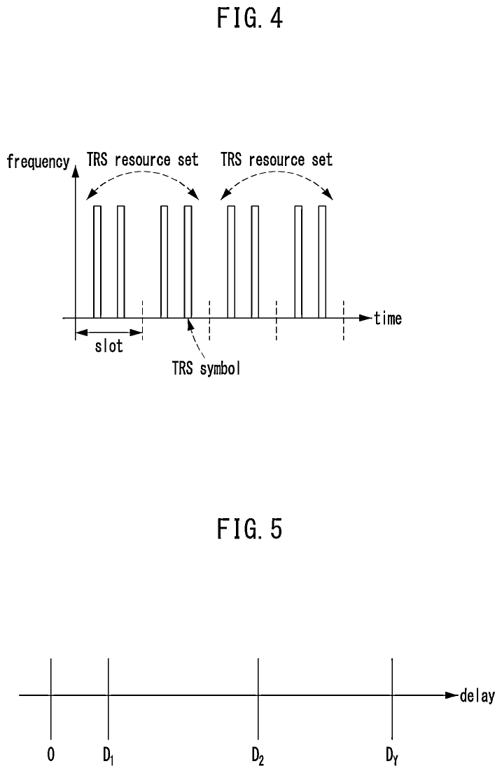

FIG. 4 is a conceptual diagram describing a relationship between TRS resource sets, slots, and TRS symbols.

Referring to FIG. 4, the terminal may derive a correlation using two TRS resource sets. For one TRS resource set, two slots may be configured to receive two TRS symbols each. Therefore, the terminal may derive the correlation using four TRS symbols.

A CSI report quantity for one or more (K=1, 2, 3) TRS resource sets may be configured (or indicated) to ‘tdcp’. The terminal may derive a correlation using the TRS resource sets. The correlation may be calculated at one or more delays (e.g. Y delays), and a range of Y and the delays may vary depending on capability of the terminal.

FIG. 5 is a conceptual diagram describing a delay for reporting a correlation of TRS.

Referring to FIG. 5, the terminal may derive a correlation and report the correlation at three delays (e.g. D₁, D₂, D₃). Here, the delays may be values configured (or indicated) by RRC signaling. The delays may be selected as one or more among 4 symbols, 1 slot, 2 slots, 3 slots, 4 slots, 5 slots, or 10 slots.

A terminal having a certain capability may calculate a correlation at one delay and satisfy a condition of ‘delay≤D’. In this case, the correlation may be expressed as a wideband amplitude, and reported to a TRP. Here, D may be a value configured (or indicated) by RRC signaling to the base station and the terminal as a predetermined value (e.g. 1 slot).

A terminal having a different capability may calculate a correlation at one delay and satisfy a condition of ‘delay>D’. In this case, the correlation may be expressed as a wideband amplitude and phase, and reported to a TRP. Alternatively, the correlation may be calculated at Y (≥1) delay(s), and if Y>1 (e.g. Y=2, 3, 4), the phase may be configured (or indicated) not to be reported.

The values of delays at which the correlation can be calculated may include at least 4 symbols, 1 slot, 2 slots, 3 slots, 4 slots, and 5 slots. In case of a subcarrier spacing (SCS) greater than 30 kHz, a delay of 10 slots may be reflected in calculating the correlation.

Since base stations or TRPs do not have ideal backhaul, a latency and capacity of a backhaul or Xn interface need to be considered. Here, the capacity refers to the maximum amount of data that TRPs are able to transmit per unit time. Since data can eventually be transmitted if a large amount of latency is tolerated, the capacity may be interpreted as the latency. Therefore, in order for TRPs to perform joint processing or joint scheduling, necessary information needs to be exchanged in advance considering the latency, so that the joint transmission can be performed using a predetermined time and frequency resource.

The TRPs may have different time synchronization and frequency synchronization. When joint scheduling is performed, synchronization between downlink signals and/or channels that the terminal receives from the TRPs needs to be secured to a certain degree. When joint processing is performed, synchronization between downlink signals and/or channels that the terminal receives from the TRPs needs to be secured to a considerable degree.

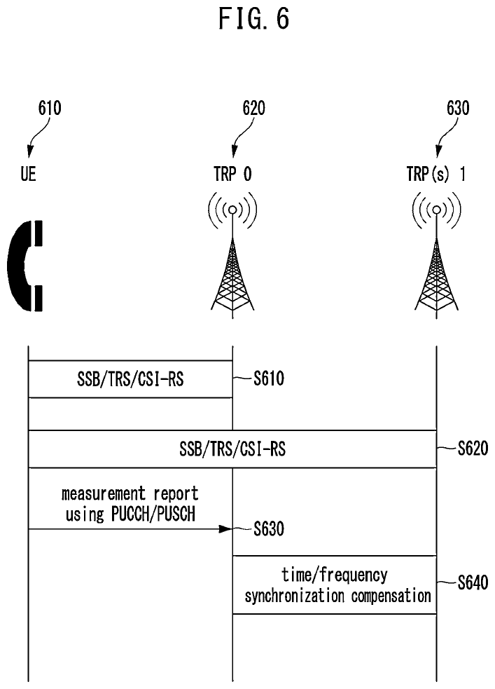

FIG. 6 is a conceptual diagram describing a time/frequency synchronization method between TRPs based on a report of a terminal according to an exemplary embodiment of the present disclosure.

Referring to FIG. 6, a method for acquiring synchronization between TRPs 620 and 630 based on a report of a terminal 610 is illustrated. DL RSs (e.g. SSB, CSI-RS, TRS) and their resources may be configured (or indicated) to the terminal from a serving TRP (or serving cell), and measurement reporting for the configured (or indicated) DL RSs may be configured (or indicated). The report generated by the terminal may include metric(s) measured by the terminal or absolute index(es) derived by the terminal.

In order to supportjoint transmission between the TRPs, the terminal may measure the DL RSs received from TRPs (i.e. the serving TRP and other TRP(s)) (S610, S620), and transmit the generated report to the serving TRP (e.g. TRP 0) (S630). The report transmitted by the terminal to the serving TRP (or information derived from the report) may be delivered to other TRP(s) (e.g. TRP 1) through an Xn interface or backhaul, may be utilized for time/frequency synchronization compensation (S640), and may be utilized for joint transmission between the TRPs.

According to a proposed method, the terminal may derive one report quantity using the DL RSs received from the respective TRPs.

The terminal may need to be able to perform coherent reception for the TRPs by compensating for a frequency offset and a time offset (or phase offset). Therefore, a measurement metric measured by the terminal may be one of a time offset (or phase offset), frequency offset, or joint offset of the time offset and frequency offset. The metric may be derived per space, per frequency, or per time, or for a combination thereof.

In an exemplary embodiment, a frequency offset and a time offset may be derived separately (per spatial basis, per time, and per frequency) for each TRP (or DL RS) as the measurement metric.

In an exemplary embodiment, only a frequency offset may be derived separately (per spatial basis, and per frequency) for each TRP (or DL RS) as the measurement metric.

In an exemplary embodiment, a joint offset of a frequency offset and a time offset may be derived separately (per spatial basis) for each TRP (or DL RS) as the measurement metric.

In an exemplary embodiment, it may be expressed as a joint index of the time offset and the frequency offset. Δf_{D}×Δt may be expressed as an index (or coefficient) for a joint basis.

In an exemplary embodiment, a separate measurement metric (e.g. correlation) may be derived separately (per spatial basis) for each TRP (or DL RS).

Here, the measurement metric derived for each DL RS may also be derived as a relative metric based on a certain one DL RS.

A Doppler-related measurement metric may be estimated at the terminal and reported to a TRP, but it may be also possible to estimate the Doppler-related measurement metric at the TRP or the base station. In this case, the terminal may derive sufficient statistics in advance in order to estimate the Doppler-related measurement metric. For example, time domain correlations or frequency domain correlations using DL RSs may be utilized.

Hereinafter, a time domain basis will be first considered. A timing at which each DL RS is received may be derived from a TCI state of the DL RS. For example, a reception timing applied to a DL RS i may be derived by referring to an SSB and/or DL RS received from a TRP i. The terminal may apply a discrete Fourier transform (DFT) window to each DL RS i, or may apply a common DFT window to DL RSs. According to a proposed method, the terminal may apply one common DFT window, and the common DFT window may be derived from a reception timing applied to a DL RS 0.

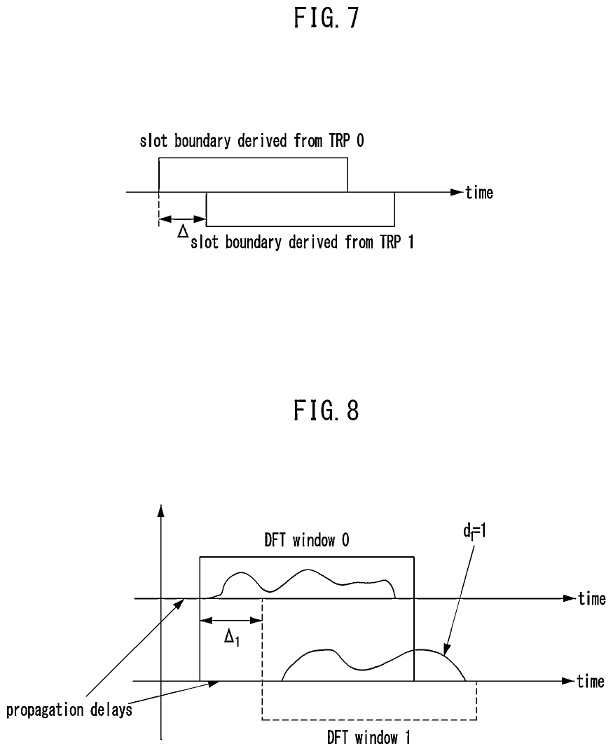

FIG. 7 is a conceptual diagram describing a method for determining a time offset between TRPs according to an exemplary embodiment of the present disclosure.

Referring to FIG. 7, the terminal may derive a slot boundary (or, subframe boundary or radio frame boundary) using a DL RS 0 received from a TRP 0. A difference between the slot boundary derived using the DL RS 0 and a slot boundary derived using a DL RS 1 received from a TRP 1 may be expressed as Δ. Alternatively, a time offset derived using the DL RS 0 and DL RS 1 may be expressed as Δᵢ.

In an exemplary embodiment, the terminal may report the derived time offset Δ to the TRP 0 which is a serving TRP. Alternatively, not only information on the time offset, but also information on other measurement metrics may be reported to the TRP 0 together. Here, the relative time offset Δᵢ derived from the DL RS 0 and DL RS 1 may be reported. A may be expressed as an index by being quantized with a uniform quantization step.

Meanwhile, there may be a case where the same DFT window is applicable to the TRP 0 and TRP 1. An OFDM symbol boundary derived using an SSB received from the TRP i may be assumed as tᵢ. If a difference tᵢ between the OFDM symbol boundaries derived from SSBs received from the TRP 0 and TRP 1 is less than a cyclic prefix (CP) length, the same DFT window may be applicable to the TRP 0 and TRP 1. If the difference tᵢ between the OFDM symbol boundaries is greater than the CP length, application of the same DFT window causes inter-symbol interference (ISI), so it is preferable to apply a separate DFT window (e.g. DFT window i) to each DL RS (e.g. DL RS i).

If the DFT windows for TRPs are different, it may be preferable for the terminal to report the fact that the DFT windows for the TRPs are different to the TRP 0 by including a separate indicator in the measurement report. For example, if a specific bit has a first value (e.g. 0), it may be indicated that the same DFT window is applied to the DL RS 0 and DL RS 1, and if the specific bit has a second value (e.g. 1), it may be indicated that different DFT windows are applied to the DL RS 0 and DL RS 1. That is, the bit may be utilized as a bit for determining whether the time offset Δᵢ derived from the DL RS 0 and DL RS 1 or a time offset considering a propagation delay and delay spread of the DL RS i exceeds a predetermined boundary. Whether a separate DFT window is used for the DL RS i may be expressed as dᵢ.

When a DFT window 0 for the DL RS 0 is applied to the DL RS 1, a report quantity measured by the terminal for the DL RS 1 may be derived. In this case, the terminal may measure the DL RS 1 using a DFT window 1 for the DL RS 1 according to a separate CSI report config (or measurement config), and derive the same report quantity. The terminal may report the derived report quantity to the TRP 0 or report a value derived using a difference between the report quantities to the TRP 0. If the DL RS 1 is measured by applying the DFT window 0, at least one of Δᵢ and Δᵢ may be reported to the TRP 0.

FIG. 8 is a conceptual diagram describing DFT windows applied to TRPs according to an exemplary embodiment of the present disclosure.

Referring to FIG. 8, the terminal may derive the DFT window 0 using the DL RS 0 received from the TRP 0. The DFT window 0 may be used to demodulate the DL RS 1 received from the TRP 1. If a propagation delay and delay spread of the DL RS 1 are too different from those of the DL RS 0, the DL RS 1 may exceed a boundary of the DFT window 0. Therefore, the DL RS 1 may generate ISI, which may be expressed as d₁=1. The terminal may report Δ₁ and d₁ to the TRP 0. Δ₁ may be quantized, and d₁ may be expressed as one bit. To this end, the minimum and maximum values that Δ₁ can have may be separately indicated to the terminal.

Hereinafter, a frequency domain basis will be considered. A frequency at which each DL RS is received may be estimated by referring to an SSB and/or DL RS received from a TRP i. When mobility of the terminal is considered, a frequency offset may occur due to a Doppler effect even if only one TRP is considered. The terminal may estimate the frequency offset using DL RSs and compensate for the frequency offset. However, when two or more TRPs are considered, the terminal cannot compensate for the frequency offset because relative movement is interpreted differently, and it may be preferable to perform pre-compensation at one of the TRPs.

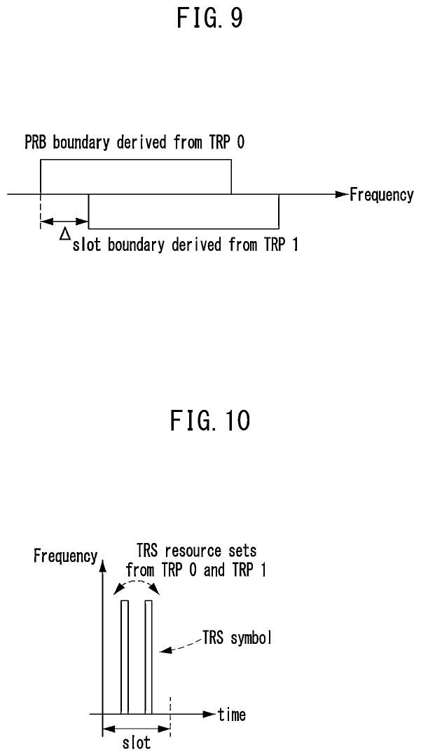

FIG. 9 is a conceptual diagram describing a method for determining a frequency offset between TRPs according to an exemplary embodiment of the present disclosure.

Referring to FIG. 9, the terminal may derive a physical resource block (PRB) boundary (or, resource grid boundary or resource element (RE) boundary) using the DL RS 0. The PRB boundary derived using the DL RS 0 and a PRB boundary derived using the DL RS 1 may have a frequency offset. The terminal may measure the frequency offset and report information derived from the frequency offset to the TRP 0 (or TRP 1). The TRPs may deliver necessary information using backhaul. For example, the TRP 1 may receive the frequency offset, perform pre-compensation using the delivered frequency offset, and then transmit the DL RS 1 to the terminal. Through this, the terminal may receive the DL RS 0 and DL RS 1 while minimizing influence of the frequency offset.

The information derived from the frequency offset may be information derived from a value normalized based on an SCS of a UL BWP. An SCS of an active UL BWP that can be received from the TRP 0 may be utilized.

In an exemplary embodiment, the frequency offset between the DL RS 0 and DL RS 1 may be reported as a relative value. The terminal may not report the value of the frequency offset derived from the DL RS 0, but may report the value Δ₁ of the frequency offset derived from the DL RS 1 to the TRP 0 (or TRP 1). Here, the relative difference in the frequency offset may be equal to a difference between the PRB boundaries. Δ₁ may be reported as an index generated by being quantized using a uniform quantization step.

If Δᵢ can be derived using a DL RS i received from a TRP i, the minimum and maximum values for quantizing Δᵢ may be separately indicated to the terminal.

Hereinafter, a time and frequency domain joint basis will be considered. Both a time offset and frequency offset may be considered for a resource grid boundary derived from a DL RS. For a resource grid boundary derived from the DL RS 0, a resource grid boundary derived from the DL RS 1 may be expressed using a joint basis. The terminal may report information expressed using the joint basis to the TRP 0 (or TRP 1). The TRPs may deliver necessary information using backhaul. For example, the TRP 1 may receive the time and frequency offsets, perform pre-compensation using the received time and frequency offsets, and then transmit the DL RS 1 to the terminal. The terminal may receive the DL RS 0 and DL RS 1 while minimizing influence of the time and frequency offsets.

Meanwhile, when considering the time offset and/or frequency offset, the terminal may measure a measurement quantity configured (or indicated) by RRC signaling. This measurement quantity may be a measurement quantity configured (or indicated) to the terminal by location positioning protocol (LPP) signaling. For example, it may be RSTD, Rx-Tx time difference, or TDCP.

Different states of a wireless channel may be estimated based on the DL RS 0 (x₀) and DL RS 1 (x₁). A wireless channel Hi may be reflected in a signal yᵢ received from a TRP i. Equation 1 below expresses a signal model of the n-th subcarrier when considering a noise z. Here, the size of the vector and matrix may correspond to the number of antennas or the number of ports.

$${y}_{0} ( n ) = {z}_{0} ( n ) + {H}_{0} {x}_{0} ( n ) \qquad [ Equation 1 ]$$

$${y}_{1} ( n ) = {z}_{1} ( n ) + {H}_{1} {x}_{1} ( n ) \cdot exp ( 2 π \sqrt{- 1} \cdot {τ}_{1} \cdot n \cdot {f}_{1} )$$

Here, τ₁ may denote a relative time offset, and f₁ may denote a relative frequency offset. Here, the time offset and frequency offset may be offsets before the TRP 1 performs pre-compensation, or may be residual offsets after being pre-compensated. For each subcarrier n, the frequency offset may be estimated by comparing y₀(n) and y₁(n).

In an exemplary embodiment, a calculation based on an inner product may be considered. Calculating an inner product for two complex vectors (y₀(n) and y₁(n)) may derive a report quantity that can express a relative phase difference of the complex vectors.

According to the conventional technical specifications, an autocorrelation may be derived only for the TRP i with the DL RS i. Through this, a measurement metric that reflects the offset caused by mobility of the terminal may be measured.

An index obtained by quantizing the measured correlation may be used as a report metric. The correlation measured using the same TRP may be used to offset the mobility of the terminal and to support mTRP operations. Additionally, in order to calculate a correlation measured from multiple TRPs, a cross-correlation for the reference TRP 0 and other TRP(s) may be measured.

According to a proposed method, a cross-correlation for two or more TRPs may be derived. Since TRPs have time offsets and/or frequency offsets even when the terminal does not move, a cross-correlation calculated for the DL RS 0 and DL RS i may be considered as a measurement metric that reflect their offsets.

The correlation may be considered as a measurement metric. In this case, the terminal may be configured (or indicated) values of delays corresponding to capability of the terminal described with reference to FIG. 5 through RRC signaling, and apply them as delays at which the correlation is calculated. For example, one or more of 4 symbols, 1 slot, 2 slots, 3 slots, 4 slots, 5 slots, or 10 slots may be selected as the delays.

After the correlation is calculated, normalization may be performed. For example, a correlation obtained at a delay greater than 0 (i.e. delay>0) may be divided by a correlation (or its magnitude or moduli) obtained at a delay equal to 0 (i.e. delay=0). In an exemplary embodiment, normalization coefficient(s) may also be included in the report metric.

For a TRS 0 received from the TRP 0 and a TRS 1 received from the TRP1, a cross-correlation between the TRS 0 and TRS 1 may be measured. Once the cross-correlation is measured, a normalized correlation may be derived. This is because a relative value of the correlation is more important than an absolute magnitude thereof. A reference value may be a correlation or inner product between the first symbols of the TRS 0 and TRS 1.

When TRSs are considered as the DL RSs described above, it may be preferable to be able to calculate a value for which the report quantity is not set to ‘none’ in the CSI report config. When the terminal is configured (or indicated) to measure ‘tdcp’ according to the conventional technical specifications, the terminal may measure TRS resources included in K TRS resource sets. It may be assumed that TRS resources belonging to one TRS resource set are transmitted from the same TRP.

According to a proposed method, the terminal may measure an autocorrelation for a TRP i and report it to the TRP 0. The terminal may measure an autocorrelation using the TRS 0 received from the TRP 0 and may measure an autocorrelation using the TRS 1 received from the TRP 1. However, according to the conventional technical specifications, a DL RS for deriving qcl-typeA of the TRS 1 may be an SSB (or another TRS) received from the TRP 1.

It may be preferable that the terminal can demodulate the TRS 1 using the resource grid boundary obtained using the TRS 0. Therefore, it may be preferable that qcl-type1 of the TRS 1 can be derived from a DL RS received from the TRP 0. However, qcl-type2 of the TRS 1 may be derived from an SSB (or another TRS) received from the TRP 1.

In an exemplary embodiment, it may be preferable that qcl-type1 of the TRS 1 can be derived from a DL RS received from the TRP 0 having a relation of qcl-typeB.

In an exemplary embodiment, it may be preferable that qcl-type1 of the TRS 1 can be derived from a DL RS received from the TRP 0 having a relation of qcl-typeB, and can be derived from a DL RS received from the TRP 1 having a relation of qcl-typeA.

In an exemplary embodiment, qcl-type2 of the TRS 1 may be derived from an SSB (or another TRS) received from the TRP 1 having a relation of qcl-typeD.

According to a proposed method, if the terminal is configured (or indicated) to measure a cross-correlation, the terminal may use K TRS resource sets. Different TRS resource sets may be received from different TRPs. Therefore, K may correspond to the number of TRPs.

The CSI report config may be associated with a list of TRS resource sets, and a report quantity may be associated with the list of TRS resource sets. The terminal may report the report quantity to the TRP 0.

It may be preferable that TRS resources belonging to a periodic/semi-persistent TRS resource set 0 (i.e. NZP CSI-RS resource set A) and an aperiodic TRS resource set 0 (i.e. NZP CSI-RS resource set B) are considered to have the same port(s). Similarly, TRS resources belonging to a periodic/semi-persistent TRS resource set 1 (i.e. NZP CSI-RS resource set C) and an aperiodic TRS resource set 1 (i.e. NZP CSI-RS resource set D) may be considered to have the same port(s). However, TRS resources having different triggering schemes (i.e. periodic, semi-persistent, or aperiodic scheme) or having the same triggering scheme but belonging to different TRS resource sets may not be considered to have the same port(s).

For example, the NZP CSI-RS resource set A and the NZP CSI-RS resource set C may not have the same port(s). For example, the NZP CSI-RS resource set A and the NZP CSI-RS resource set B may not have the same port(s). For example, the NZP CSI-RS resource set B and the NZP CSI-RS resource set C may not have the same port(s). For example, the NZP CSI-RS resource set B and the NZP CSI-RS resource set D may not have the same port(s).

An identifier of a TRP may be indicated separately in the TRS resource set, or may be implicitly derived from an identifier of a DL RS that provides a DL/joint TCI state that the TRS resource refers to.

Slots in which TRS resource sets are received may be distinguished from each other within the same TRP. This is because a purpose of TRS used by the terminal is DL maintenance (i.e. time tracking, frequency tracking), and therefore, temporally distributed TRS symbols are required. Therefore, if the terminal directly compensates/offsets the time offset and/or frequency offset between the TRPs measured using the TRSs, or reports the measured time offset and frequency offset to the TRP 0 so that the TRPs compensate/offset, improvement of the conventional TRS resource set may be required.

The terminal may derive predetermined measurement metrics using the TRS resource set. In an exemplary embodiment, the terminal may report the derived measurement metrics to the TRP 0 in accordance with the CSI report config. In another exemplary embodiment, the terminal may report the derived measurement metrics to the TRP 0 as part of radio resource management (RRM).

As a configuration of the CSI report config, the measurement metrics may be derived. In this case, it may be preferable that the terminal can utilize TRS resources received from two or more TRPs in the same measurement resource. Therefore, it may be preferable that the TRPs ensure that the terminal can perform coherent reception in the corresponding measurement resource. Here, the measurement resource may refer to a time resource and frequency resource configured (or indicated) to the terminal, and may not necessarily be composed of only TRS resources.

According to a proposed method, two or more TRS resource sets may be received in the same slot. The two TRS resource sets may be received from different TRPs. TRS symbols may have specific positions within the slot.

In an exemplary embodiment, a position of a TRS symbol in which the TRS is transmitted may be changed. In this case, the terminal may directly apply the method of utilizing multiple NZP CSI-RS symbols for DL maintenance.

In an exemplary embodiment, a position of a frequency in which the TRS symbol is transmitted may be changed. Since the TRS symbol follows the configuration of NZP CSI-RS symbol, a different subcarrier offset may be allocated to each TRP. In this case, the terminal may receive orthogonal TRS resource sets from the TRPs.

FIG. 10 is a conceptual diagram describing configuration of TRS resource sets according to an exemplary embodiment of the present disclosure.

Referring to FIG. 10, TRS symbols received from two TRPs within one slot are illustrated. The above configuration may be easily extended to two consecutive slots. The TRS symbols may belong to different TRS resource sets by being frequency division multiplexed (FDMed).

If a TRS symbol received from the TRP 0 and a TRS symbol received from the TRP 1 have different time offsets and/or frequency offsets, it may be difficult for the terminal to derive a measurement metric from the TRP symbols within the same slot. In this case, the terminal may assume that the TRS is received only in a part of the measurement resources.

In an exemplary embodiment, two consecutive slots are considered as measurement resources, but the TRS may be received only in one slot. The slot(s) in which the TRS from the TRP 0 are received and the slot(s) in which the TRS from the TRP 1 are received may be different from each other, and the terminal may assume that DL reception coherence is maintained in the consecutive slots. That is, it means that the TRS received from the TRP 1 is measured while maintaining DL reception coherence even in the slot in which the TRS received from the TRP 0 is not measured. Here, the DL reception coherence may be assumption of the terminal and may indicate that reception phase continuity is maintained.

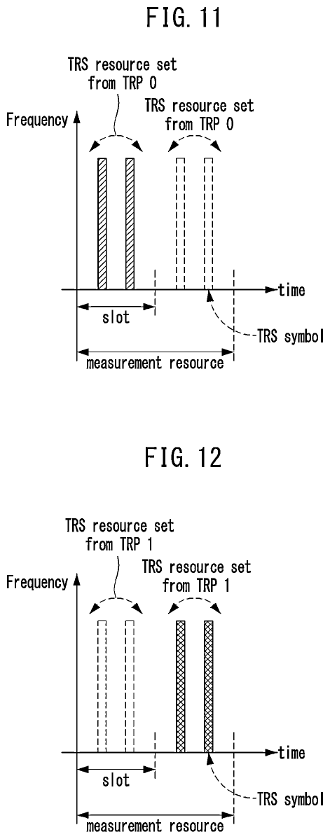

FIG. 11 and FIG. 12 are conceptual diagrams describing configuration of TRS resource sets according to an exemplary embodiment of the present disclosure.

Referring to FIG. 11 and FIG. 12, the terminal considers measurement resources as two consecutive slots, but the TRS received from the TRP 0 may be received in the first slot (FIG. 11), and the TRS received from the TRP 1 may be received in the second slot (FIG. 12). Since the terminal maintains reception coherence in the measurement resources, the terminal may process the TRSs received in different slots to derive a measurement metric.

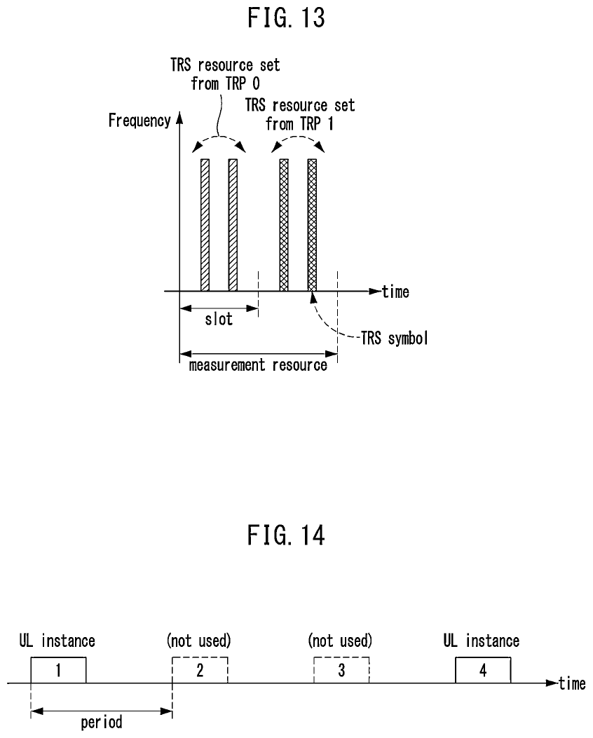

FIG. 13 is a conceptual diagram illustrating the TRP resource sets illustrated in FIGS. 11 and 12 in one drawing.

Referring to FIG. 13, the TRSs of the TRP 0 and TRP 1 are received by being time division multiplexed (TDMed) with each other and may belong to the same measurement resource.

Meanwhile, a periodic/semi-persistent TRS may be configured (or indicated) to the terminal, and an aperiodic TRS may be configured (or indicated) to the terminal. By receiving the periodic/semi-persistent TRS from the TRP 0, the terminal may receive DL signals and/or channels from the TRP 0. In order to perform joint reception from the TRP 0 and TRP 1, it may not be necessary to receive a periodic/semi-persistent TRS from the TRP 1. This is because the terminal can perform DL maintenance even if it receives an SSB from the TRP 1 and receives only an aperiodic TRS based on the SSB.

Therefore, according to a proposed method, only aperiodic TRS resource set(s) may be configured (or indicated) to the terminal for TRS(s) received from a TRP other than the TRP 0. That is, when reception of a periodic/semi-persistent TRS is configured (or indicated) from one of TRPs that are targets of joint reception, only an aperiodic TRS may be configured (or indicated) to be received from other TRP(s).

When receiving TRSs from K TRPs, the terminal may need to consume CSI processing units (CPUs) to derive a measurement metric. For convenience of description, an amount of consuming CPUs may be referred to as a value that is directly proportional to O. O may represent a computational complexity of the measurement metric.

In an exemplary embodiment, O may be proportional to K (i.e. the number of TRPs). Here, the proportional relationship may be expressed as a linear function or an affine function.

In an exemplary embodiment, O may be proportional to Y (i.e. the number of delay(s) of correlation calculation).

For example, if correlation is a measurement metric, (1+Y) delays may be considered, including delay=0. O may be determined proportionally to a product of K and (1+Y).

The terminal may perform reporting in a different manner according to a configured measurement metric. For example, in the case of RRM measurement, since the report is reported as a result of mobility through RRC signaling, the report may be included in a PUSCH. For example, in the case of CSI measurement, since the report is reported as a result of fading through UCI, the report may be included in a PUCCH (or PUSCH).

According to the conventional technology, configured grant(CG)-UCI may be used in a system operating in an unlicensed band. If a listen-before-talk (LBT) procedure for communication in an unlicensed band fails, the terminal may not transmit a CG PUSCH. In this case, rather than transmitting a separate TB each time, CG-UCI may be added so that a TB that was not transmitted can be transmitted by being deferred. The terminal may transmit scheduling information of the TB to be transmitted on the CG PUSCH to the base station by using some fields of the CG-UCI. For example, these fields may be a HARQ process ID (HPID), redundancy version (RV), new data indicator (NDI), and/or the like. That is, the terminal may decide whether to transmit a new TB or retransmit the previous TB at its own discretion. On the other hand, if the CG-UCI is not configured for the terminal, the HPID in the corresponding CG PUSCH may be determined as a function of time (i.e. a slot or the first symbol in which the CG PUSCH is transmitted, etc.) and retransmission cannot be performed at the discretion of the terminal.

The terminal may report information related to a quality of a beam measured using a DL RS to the base station. For example, L1 RSRP, L1 SINR, or other metrics may be measured. A trigger condition for reporting may be defined in the technical specifications or indicated to the terminal by RRC signaling.

According to the conventional technical specifications, information related to a quality of a beam may be reported periodically. This may be performed in the form of periodic reporting or semi-persistent reporting. The terminal may report the information to the base station using a PUCCH or PUSCH.

According to a proposed method, in order to report information related to a quality of a beam, a PUCCH or PUSCH may be transmitted in a time resource determined by the terminal. Here, the time resource may be a slot, a sub-slot, or a symbol. A given time resource may be indicated to the terminal by RRC signaling or may be activated using a combination of RRC signaling and MAC signaling. The time resource may occur periodically, but only some instances may be utilized.

FIG. 14 is a conceptual diagram describing a method of transmitting beam quality-related measurement information in preconfigured time resources according to an exemplary embodiment of the present disclosure.

Referring to FIG. 14, four instances are illustrated, and the terminal may transmit UCI using only the first and fourth instances. That is, the terminal may not transmit UCI in the second and third instances. According to the conventional technical specifications, the terminal needs to transmit UCI in all four instances. However, according to a proposed method, depending on a condition for transmitting UCI, the terminal may not transmit UCI in certain instance(s).

According to a proposed method, event(s) that can be utilized in RRM measurement may be similarly defined in the physical layer. This is because in RRM measurement, events A1 to A5 are defined using layer 3 (L3) RSRP, and thus the terminal can use them for mobility management. Since the RRM measurement result is transmitted through RRC signaling, a PUSCH may be scheduled by the base station using buffer status reporting. Either dynamic grant PUSCH or configured grant PUSCH may be utilized.

According to the conventional technical specifications, several PUCCH resources for transmitting UCI are indicated to the terminal, and the terminal may select a PUCCH resource according to the amount of UCI to be reported. Alternatively, some of the indicated PUCCH resources may be changed and utilized to transmit UCI. For example, a list of PUCCH resources may be indicated to the terminal. The number of REs required for the PUCCH resource may be derived according to the amount of UCI to be reported and a code rate required by the UCI. According to the technical specifications, the terminal may select one of PUCCH resources for which a sufficient number of REs are secured. For example, it may be assumed that a first PUCCH resource has N1 REs and a second PUCCH resource has N2 REs. When N REs are required to report UCI and N1≤N≤N2, the terminal may select the second PUCCH resource. Even if a third PUCCH resource has N3 REs and N2<N3, the terminal may select the second PUCCH resource corresponding to N2, which is closest to N.

A bandwidth may also be reduced for the selected PUCCH resource. If the PUCCH is transmitted using N1 REs, the number of PRBs may be reduced while maintaining a waveform of the PUCCH. That is, the number of PRBs may be reduced under a condition that the number of PRBs (i.e. bandwidth) of the PUCCH satisfies a multiple of 2, 3, or 5. Here, even if the reduced PRBs are used, the number of symbols transmitted through the PUCCH needs to be maintained, and the UCI(s) belonging to the N REs need to satisfy the code rate.

According to a proposed method, a UCI type may be introduced or the conventional UCI may be modified/improved to indicate new UCI. According to events defined in the physical layer, an identifier of the event and an index derived from a quality of a beam (e.g. L1 RSRP or L1 SINR), an identifier of the beam (or an identifier of RS, an identifier of TCI state) may be included. The new UCI may be defined by introducing specific field(s) in CG-UCI from the conventional technical specifications. The identifier of the event may be included according to a value of a field. In this case, identifiers of RSs required for the event and a quality of the corresponding RSs may be included in the UCI. If multiple events occur in the terminal, only one event may be selected according to priorities of the events. The priorities of the events may be determined according to the technical specifications, and the terminal may reflect only an identifier for one event in the new UCI.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving a first downlink (DL)-reference signal (RS) and a second DL-RS from a first transmission and reception point (TRP) and a second TRP among two or more TRPs;
reporting a measurement report based on the first DL-RS and the second DL-RS to one TRP among the first TRP and the second TRP; and
receiving data through joint transmission performed by the first TRP and the second TRP based on the measurement report.

2. The method according to claim 1, wherein each of the first DL-RS and the second DL-RS is at least one of a synchronization signal block (SSB), a channel state information (CSI)-RS, or a tracking reference signal (TRS).

3. The method according to claim 1, wherein the one TRP is the first TRP, which is a serving TRP for the terminal, and the measurement report or information derived from the measurement report is transmitted from the first TRP to the second TRP via backhaul or Xn interface.

4. The method according to claim 1, wherein the measurement report includes at least one of a time offset measured between the first DL-RS and the second DL-RS, a frequency offset measured between the first DL-RS and the second DL-RS, or a joint offset of the time offset and the frequency offset, and follows a CSI report configuration.

5. The method according to claim 4, wherein the time offset, the frequency offset, or the joint offset is included in the measurement report as an absolute value or a relative value.

6. The method according to claim 1, wherein the first DL-RS and the second DL-RS are received with a common discrete Fourier transform (DFT) window applied, or are received with different DFT windows applied.

7. The method according to claim 6, wherein when different DFT windows are applied to the first DL-RS and the second DL-RS, the measurement report includes an indicator indicating that different DFT windows are applied to the first DL-RS and the second DL-RS.

8. The method according to claim 1, wherein the measurement report includes at least one of an autocorrelation measured for each of the first DL-RS and the second DL-RS or a cross-correlation measured for the first DL-RS and the second DL-RS.

9. The method according to claim 1, wherein when the first DL-RS and the second DL-RS are TRSs, the first DL-RS and the second DL-RS are received and measured in different slots, and downlink reception coherence of the terminal is assumed to be maintained in the different slots.

10. The method according to claim 1, wherein a periodic or semi-persistent reporting according to a CSI report framework is configured for one DL-RS among the first DL-RS and the second DL-RS, and an aperiodic reporting according to the CSI report framework is configured for another DL-RS among the first DL-RS and the second DL-RS.

11. A method of a first transmission and reception point (TRP), comprising:
transmitting a first downlink (DL)-reference signal (RS) to a terminal;
receiving, from the terminal, a measurement report based on the first DL-RS and a second DL-RS transmitted by a second TRP to the terminal; and
transmitting data to the terminal by performing joint transmission together with the second TRP based on the measurement report.

12. The method according to claim 11, wherein the first DL-RS is at least one of a synchronization signal block (SSB), a channel state information (CSI)-RS, or a tracking reference signal (TRS).

13. The method according to claim 11, wherein the first TRP is a serving TRP for the terminal, and the measurement report or information derived from the measurement report is transmitted from the first TRP to the second TRP via backhaul or Xn interface.

14. The method according to claim 11, wherein the measurement report includes at least one of a time offset measured between the first DL-RS and the second DL-RS, a frequency offset measured between the first DL-RS and the second DL-RS, or a joint offset of the time offset and the frequency offset, and follows a CSI report configuration.

15. The method according to claim 11, wherein when the terminal applies different DFT windows to the first DL-RS and the second DL-RS, the measurement report includes an indicator indicating that different DFT windows are applied to the first DL-RS and the second DL-RS.

16. The method according to claim 11, wherein the measurement report includes at least one of an autocorrelation measured for each of the first DL-RS and the second DL-RS or a cross-correlation measured for the first DL-RS and the second DL-RS.

17. A terminal comprising:
at least one processor; and
a transceiver,
wherein the at least one processor is configured to perform:
receiving, through the transceiver, a first downlink (DL)-reference signal (RS) and a second DL-RS from a first transmission and reception point (TRP) and a second TRP among two or more TRPs;
reporting, through the transceiver, a measurement report based on the first DL-RS and the second DL-RS to one TRP among the first TRP and the second TRP; and
receiving, through the transceiver, data through joint transmission performed by the first TRP and the second TRP based on the measurement report.

18. The terminal according to claim 17, wherein each of the first DL-RS and the second DL-RS is at least one of a synchronization signal block (SSB), a channel state information (CSI)-RS, or a tracking reference signal (TRS).

19. The terminal according to claim 17, wherein the one TRP is the first TRP, which is a serving TRP for the terminal, and the measurement report or information derived from the measurement report is transmitted from the first TRP to the second TRP via backhaul or Xn interface.

20. The method according to claim 17, wherein the measurement report includes at least one of a time offset measured between the first DL-RS and the second DL-RS, a frequency offset measured between the first DL-RS and the second DL-RS, a joint offset of the time offset and the frequency offset, an autocorrelation measured for each of the first DL-RS and the second DL-RS, or a cross-correlation measured for the first DL-RS and the second DL-RS.
